(19) United States
(12) Patent Application Publication
(10) Pub. No.: US 2012/0248230 A1
(43) Pub. Date: Oct. 4, 2012

(54) DOCUMENT SHREDDER

(75) Inventors: GERHARD ZAPF, EBERN (DE); DIETER PÖSCHL, STEINBACH (DE); THOMAS SCHOLZ, SCHALKAU (DE)

(73) Assignee: DAHLE BUEROTECHNIK GMBH, ROEDENTAL (DE)

(21) Appl. No.: 13/480,112

(22) Filed: May 24, 2012

Related U.S. Application Data
(63) Continuation of application No. PCT/EP2010/005491, filed on Sep. 7, 2010.

(30) Foreign Application Priority Data
Nov. 24, 2009 (DE) 20 2009 015 982.5
Dec. 9, 2009 (DE) 20 2009 016 673.2

(51) Int. Cl. B02C 23/08; E03B 7/07; B02C 18/06

(52) U.S. Cl. 241/60; 241/101.3; 241/220; 137/544

(57) ABSTRACT

A document shredder has a housing wall interrupted by an insertion opening of a feed channel for the material to be comminuted. A cutting unit adjoins the feed channel in the insertion direction of the material to be comminuted. A suction-extraction device has an intake end opening into the feed channel and intended for sucking the air stream out of the feed channel. A filter element in the blow-out opening filters out fine dust particles before the suction-extracted air is blown out of the document shredder housing into the surroundings.

### CROSS-REFERENCE TO RELATED APPLICATION

This application is a continuation, under 35 U.S.C. §120, of copending international application No. PCT/EP2010/005491, filed Sep. 7, 2010, which designated the United States; this application also claims the priority, under 35 U.S.C. §119, of German application No. DE 20 2009 015 982.5, filed Nov. 24, 2009, and German patent application No. DE 20 2009 016 673.2, filed Dec. 9, 2009; the prior applications are herewith incorporated by reference in their entirety.

### BACKGROUND OF THE INVENTION

### Field of the Invention

The invention relates to a document shredder for use in offices. The material to be comminuted with the aid of this document shredder is generally a stack of paper sheets of coated or normal paper or recycled paper. In addition, the material to be comminuted can be present in the form of plastic films, such as are used on overhead projectors, or in the form of computer floppy disks and so-called compact discs, designated “CD” for short, or of digital versatile disks, called “DVD” for short.

A file shredder, known from WO 2007/137761 A1, for example, has a housing, the upper side of which is interrupted by an infeed slot for the material to be comminuted. Underneath the infeed slot in the housing there is provided a cutting unit. This cutting unit generally comprises two cutting rolls rotating in opposite directions to each other and driven by electric motors. In each case a multiplicity of cutting disks are arranged beside one another on the cutting roll. The cutting disks in turn have teeth for comminuting the material to be comminuted. The material to be comminuted is effectively ground during its passage through the mutually opposite cutting rolls.

In the course of the increased awareness of the emission of fine dust from office machines, there is discussion as to whether, for example, copiers or printers emit fine dust particles. Dust having a particle size of <10 μm is described as fine dust. Here, a distinction is further drawn within fine dust that can be inhaled having an average particle size <10 μm. Fine dust that can enter the lungs has a particle size <2.5 μm. Finally, one speaks of ultrafine particles with a particle size <0.1 μm. The factor common to all these types of fine dust is that the fine dust is not visible to the human eye in the surrounding air.

In conjunction with the afore-mentioned office machines, to all of which it is common that—similar to an office computer—they have a ventilation fan for leading heat out of the device, discussions are ongoing in relation to providing a filter element in the blow-out opening of this ventilation fan in order to filter out fine dust particles.

In the context of document shredders, the idea has already been developed of sucking the material to be comminuted into the device underneath the cutting unit. This is known, for example, from Japanese patent application JP 424 00 95 A dated Aug. 27, 1992. Also, Japanese patent application JP11 347 435 A dated Dec. 21, 1999 discloses a further document shredder with a suction extraction device arranged underneath the cutting unit and above the collecting container for the material to be comminuted.

However, neither suction extraction device is suitable for sucking the fine dust out of a document shredder. As a result of the work performed by the cutting unit, there is a high development of heat in the area of the cutting unit. As a result of this development of heat, warm air rises from the cutting unit of the document shredder. Since the fine dust particles are very small and very light, the fine dust particles rise together with the warm air from the cutting unit and as a rule are emitted from the document shredder to the outside through the infeed slot.

Added to this is the fact that, even without any development of heat in the cutting unit, the fine dust particles tend to rise away from the cutting unit in the feed channel of the document shredder in the direction of the infeed slot, in order to be emitted from the document shredder via the infeed slot. This emission behavior of the fine dust particles is intensified further by the above-described development of heat and the warm air therefore rising.

### SUMMARY OF THE INVENTION

It is accordingly an object of the invention to provide a shredder which overcomes the above-mentioned disadvantages of the heretofore-known devices and methods of this general type and which provides for an improved document shredder with regard to its fine dust emission behavior and, more generally, for a document shredder that is improved with regard to its characteristics in use.

With the foregoing and other objects in view there is provided, in accordance with the invention, a document shredder, comprising:

a housing wall formed with an infeed opening into a feed channel for material to be comminuted;

a cutting unit following the feed channel in an infeed direction of the material to be comminuted;

a suction extraction device having an intake end opening into said feed channel for extracting an air stream out of said feed channel, said suction extraction device having a filter element at a blow-out opening for filtering out fine dust particles before warm air extracted by said suction extraction device is blown out of the document shredder housing into the surroundings.

Furthermore, the invention also further includes detection of thickness, itself inventive per se, for the thickness of the material to be comminuted, and a device, likewise itself inventive per se, for the automatic periodic lubrication of the cutting unit.

In order to improve the fine dust particle emission behavior, a document shredder is proposed, having a housing wall interrupted by an infeed opening of a feed channel. The material to be comminuted is introduced into the feed channel of the document shredder through the infeed opening. In the infeed direction of the material to be comminuted, the cutting unit follows the feed channel. At the same time, a suction extraction device opens into the feed channel. The suction extraction device is connected by its intake end to the feed channel. The suction extraction device sucks in via its intake end the air stream rising in the feed channel and in particular the warm air originating from the cutting unit, and leads air stream and warm air on to a blow-out opening. Via the blow-out opening, air stream and warm air are led out of the document shredder. A filter element is connected upstream of the blow-out opening. This filter element is specifically suitable for filtering out fine dust particles.

The invention is based on the fundamental idea of connecting the interior of the document shredder to the suction extraction device and arranging the intake end above the cutting unit for this purpose. The intake end is arranged in the feed channel, in order in this way to extract the whole of the air stream with the warm air out of the feed channel leading the warm air from the cutting unit upward in the manner of a flue, in order in this way also to entrain all the fine dust particles.

This arrangement of the intake end of the suction extraction device also has the advantage that no coarse particles of the material to be comminuted are also extracted. This is because these coarse particles first accumulate underneath the cutting unit and, because of their inherent weight, fall into a corresponding collecting container arranged underneath the cutting unit in the usual way. Extracting these coarse particles would have the disadvantage that they could block the filter element, so that either the air extracted by the suction extraction device could no longer escape from the suction extraction device and therefore from the housing of the document shredder, or the coarse particles could be deposited on the filter element with the consequence that the filter action of the filter element in relation to the fine dust particles is impaired.

With the invention, it is readily possible to extract the major part of the fine dust particles occurring as a result of the comminution process in the document shredder, so that the fine dust loading on the surrounding air of the document shredder is reduced significantly.

The widening of the feed channel that is preferably provided to form an infeed hopper has the advantage that the material to be comminuted can be introduced into the document shredder simply and without precise insertion. The arrangement of the intake end of the suction extraction device in the region of the infeed hopper benefits the extraction of the warm air or waste air loaded with fine dust particles over the greatest possible distance of the feed channel between the infeed opening and the cutting unit. In order to increase the efficiency of the extraction operation, it is advantageous to extract particularly close to the point of origin of the fine dust particles. On account of the fine dust particles rising with the warm air produced in the cutting unit, it would therefore theoretically be advantageous to extract the fine dust particles directly above the cutting unit. However, tests have shown that it is not detrimental if the warm air enriched with the fine dust particles initially rises in the feed channel in order to be extracted at the lower end of the infeed hopper, facing the feed channel. The arrangement of the intake nozzle or the intake end at the lower end of the infeed hopper, facing the feed channel, has the advantage that sufficient installation space is available there for the intake nozzle or the intake end.

An intake end of the suction extraction device configured as a suction nozzle ensures a particularly high suction action of the suction extraction device. The preferred nozzle-like configuration of the suction extraction device significantly benefits the flow behavior of the outlet stream extracted and therefore increases the efficiency of the suction extraction device. The arrangement of the suction fan in the direct vicinity of the filter element promotes the feeding of all the fine dust particles into the filter element. In this way, fine dust particles are effectively prevented from remaining in the suction extraction device and, after the suction extraction device has been switched off, getting into the feed channel again through the intake end.

The use of a multilayer filter insert consisting of microfibers increases the efficiency and therefore the filtering performance of the device.

The configuration of the suction extraction device as an integral component, which comprises an intake end formed as an intake nozzle, the suction fan, the filter element and the terminating grille at the blow-out end, ensures firstly that the whole of the air stream extracted with the fine dust particles is led out of the interior of the document shredder into a region likewise sealed off hermetically from the surrounding air. This virtually hermetically sealed area prevents undesired diffusion of the air stream containing the fine dust particles to the outside. Instead, it is ensured that the air stream must first flow through the filter element before it is blown out into the surroundings. Here, the filter element ensures the effective separation of the warm air stream from the fine dust particles found in the air stream. In this way, it is ensured that the fine dust particles pass reliably into the filter element and are thus filtered out of the air stream.

In addition, the extraction subassembly created in this way can be tested reliably for tightness before being installed in the document shredder, so that it is ensured that a leaky suction extraction device does not stop the fine dust particles being filtered out during operation. Finally, the configuration of the suction extraction device as an integral component also principally makes it possible to retrofit such a suction extraction device subsequently in suitable and existing document shredders.

The rectangular cross-sectional shape of the feed channel, proposed in a preferred refinement, permits functional separation such that the one long side of the feed channel is effective as a mounting flange for the suction end, in particular the suction end of the suction extraction device configured as an intake nozzle, while the respectively opposite long side is used as a mounting surface for an inventive detector for measuring the thickness of the material to be comminuted. In an advantageous refinement, the feed channel is formed from two C-shaped half shells that can preferably be latched in each other.

The structure of the detector is very simple. A mechanically mobile sensing finger interacts with a thin-film potentiometer here. Via the sensing finger, the thickness of the material to be comminuted is detected reliably and securely. The thin-film potentiometer generates an electric signal to the machine control system as a function of the thickness of the material to be comminuted. Depending on this signal, the drive of the document shredder is stopped immediately in the event of too high a thickness of the material to be comminuted. On the other hand, if the thickness of the material to be comminuted moves within a permissible interval, the electric drive of the cutting unit can start up. At the same time, the suction extraction device for the fine dust particles is also activated.

The arrangement of the intake end of the suction extraction device on one long side of the feed channel, on the one hand, and of the detector according to the invention on the opposite long side of the feed channel, on the other hand, leads to a clean functional separation within the document shredder.

Finally, the ability of the cutting unit of a document shredder to function is ensured only when the cutting rolls are lubricated with a suitable oil at regular intervals. Otherwise, there is the risk that the cutting rolls will be clogged with coarse particles from the material to be comminuted and, so to speak, blocked. Furthermore, the lubrication has the task of reducing the friction in the area of the intermeshing cutting rolls. From experience, the regular periodic re-lubrication of the cutting unit in document shredders is generally forgotten by the operator despite a small can of oil also being supplied. Over the long term, the clogging of the cutting unit with cut particles can lead to failure of the cutting unit and therefore to failure of the entire document shredder.

For the purpose of periodic lubrication, a trough extending over the shaft width of a cutting roll is therefore provided in accordance with the invention. This trough is arranged above a cutting roll and projects somewhat beyond the cutting roll as far as the area of overlap with the opposite cutting roll. The side wall of the trough that faces the opposite cutting roll has a multiplicity of apertures. If the trough is filled with lubricating oil, the oil flows out of the trough through the apertures and drips into the area between the two mutually opposite shafts. For the purpose of uniform distribution of the oil in the trough, webs arranged offset with respect to one another, which stand up from the base of the trough, are provided. These webs form a labyrinth-like partitioning of the trough base. As a result of this labyrinth-like subdivision of the trough base, a quantity of lubricating oil flowing into the trough is distributed uniformly over the base of the trough, which ensures that approximately the same quantity of lubricating oil is led out of the trough in the direction of the cutting rolls via each of the aforementioned apertures. In order to lubricate the cutting rolls, at periodic intervals, a certain quantity of oil is sprayed or led into the trough from an oil reservoir arranged permanently in the document shredder or connected to the document shredder. As a result of the labyrinth-like configuration of the base of the trough, the individual parts of the cutting unit are thoroughly lubricated uniformly.

Other features which are considered as characteristic for the invention are set forth in the appended claims.

Although the invention is illustrated and described herein as embodied in a document shredder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a sectioned view of the housing cover with integrated infeed hopper and adjacent feed channel with suction extraction device connected to the feed channel, with detector adapted to the feed channel for measuring the height of the material to be comminuted and with the device for lubricating the cutting unit;

FIG. 2 shows a view from below into the housing cover with feed channel fixed thereto and with suction extraction device flange-mounted on the feed channel;

FIG. 3 shows the subassembly comprising feed channel with detector fitted thereto for measuring the thickness of the material to be comminuted and with suction extraction device connected;

FIG. 4 shows a further sectioned illustration of the housing cover with a view of the feed channel and the intake end of the suction extraction device opening into the feed channel;

FIG. 5 shows a perspective view of a suction extraction device configured as an integral component;

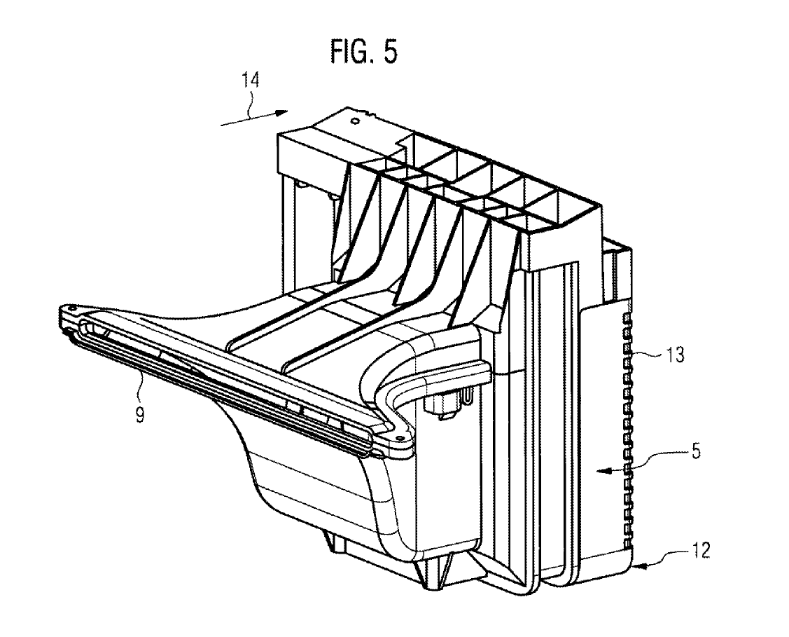

FIG. 6 shows a perspective view of the feed channel with a detector for measuring the thickness of the material to be comminuted;

FIG. 7 shows a plan view of the cutting unit with lubricating apparatus arranged above;

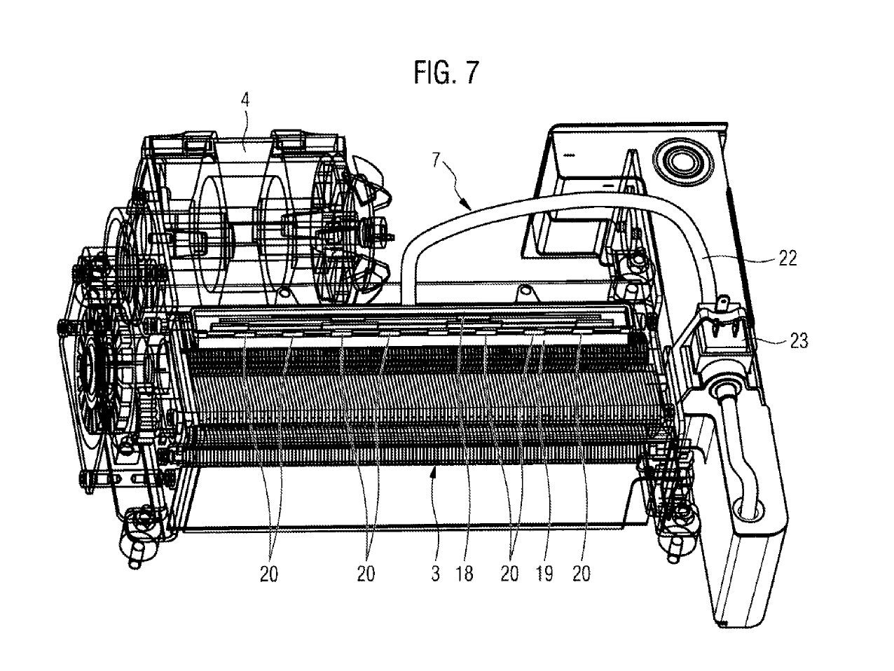

FIG. 8 shows a detailed view of the trough of the lubricating apparatus from FIG. 7; and

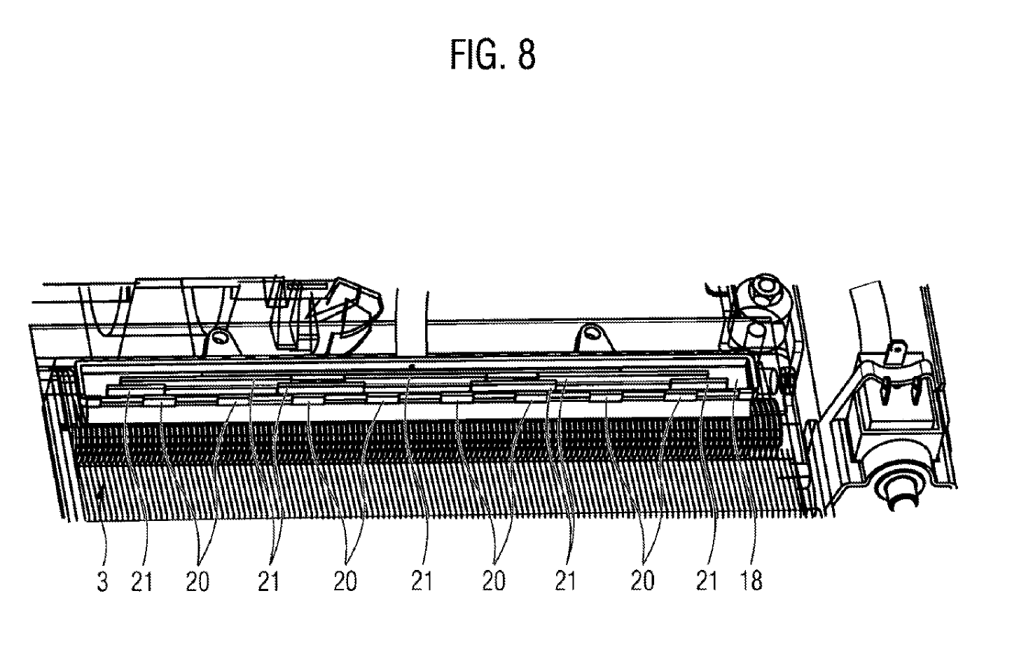

FIG. 9 shows a comparison of the fine dust particle output from a document shredder having the suction extraction device according to the invention, on the one hand, and one without a suction extraction device, on the other hand.

### DETAILED DESCRIPTION OF THE INVENTION

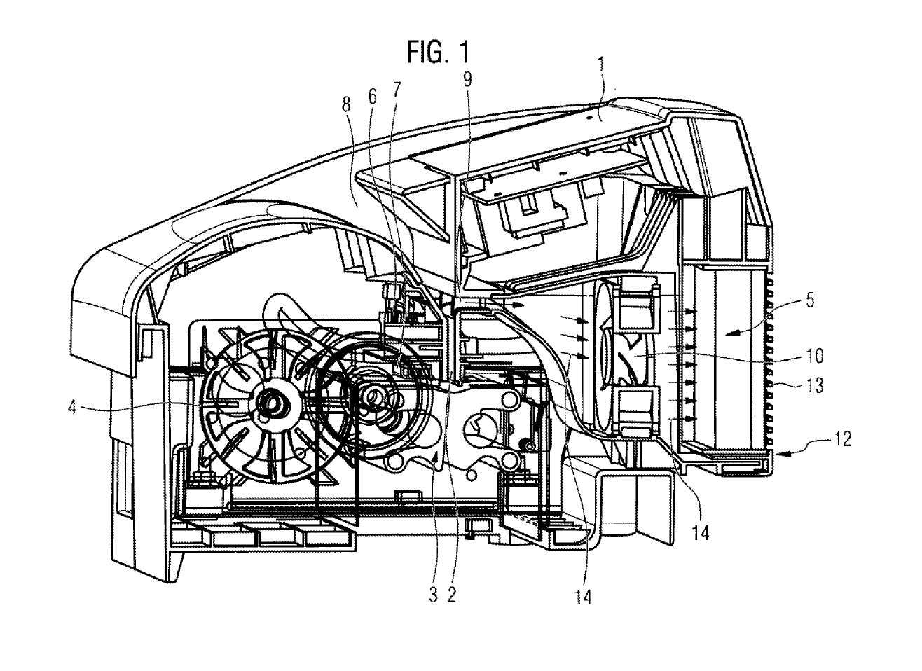

Referring now to the figures of the drawing in detail and first, particularly, to the sectional view of FIG. 1 thereof, there is shown a document shredder which, according to the invention has a housing in the form of a cabinet. The cabinet is not illustrated in order not to complicate the illustration. A collecting container for the comminuted, or shredded, material is arranged in the cabinet. Arranged above the collecting container is a subassembly comprising a housing cover 1, a feed channel 2, a cutting unit 3, a drive motor 4, a suction extraction device 5, a detector 6, and a lubricating apparatus 7. This subassembly is shown in FIG. 1 in a sectioned illustration. FIG. 1 further shows that the housing cover, which forms the upper termination of the housing wall, is interrupted by an infeed hopper 8. The infeed hopper 8, or feed chute 8, encloses the end of the feed channel 2 on the housing cover side. The infeed hopper 8 therefore opens directly into the feed channel 2. Also arranged in the region of the infeed hopper 8 is the intake end of the suction extraction device 5, configured as an intake nozzle 9.

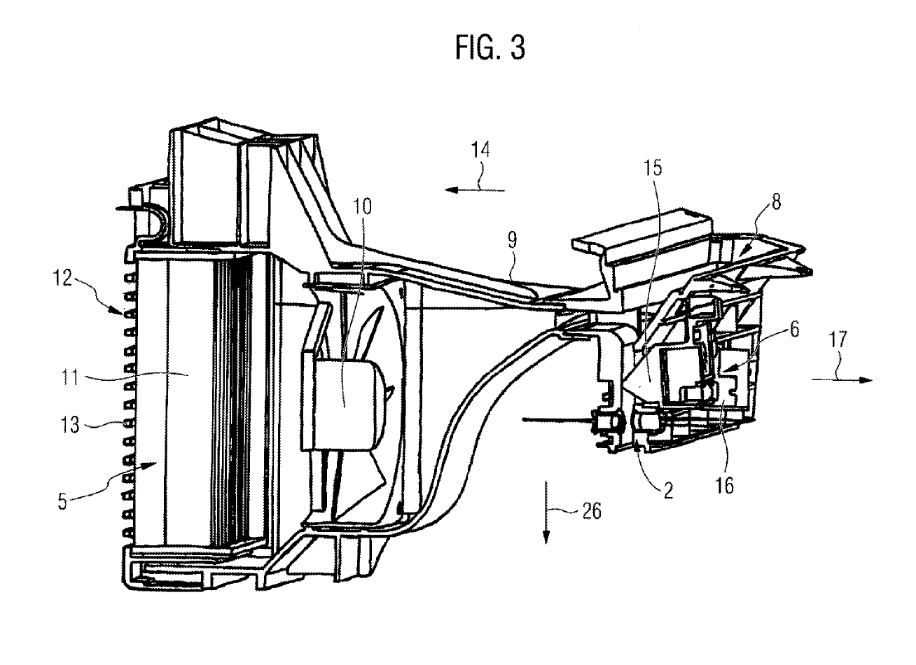

In turn, as can be seen in FIG. 3, the suction extraction device 5 comprises the intake nozzle 9. The intake nozzle 9 here forms the intake end of the suction extraction device 5. The suction extraction device 5 widens from the intake nozzle 9 in the manner of a nozzle. In the region of the blow-out end of the suction extraction device 5, the suction fan 10 is arranged first. Directly adjacent to the suction fan 10 is the filter element 11. In the region of the blow-out end, the suction extraction device 5 is closed off by the terminating grille 13. The air stream rising from the cutting unit 3 and containing the fine dust particles is extracted by the suction fan 10 via the intake nozzle 9 and flows through the interior of the suction extraction device 5 in the suction direction 14.

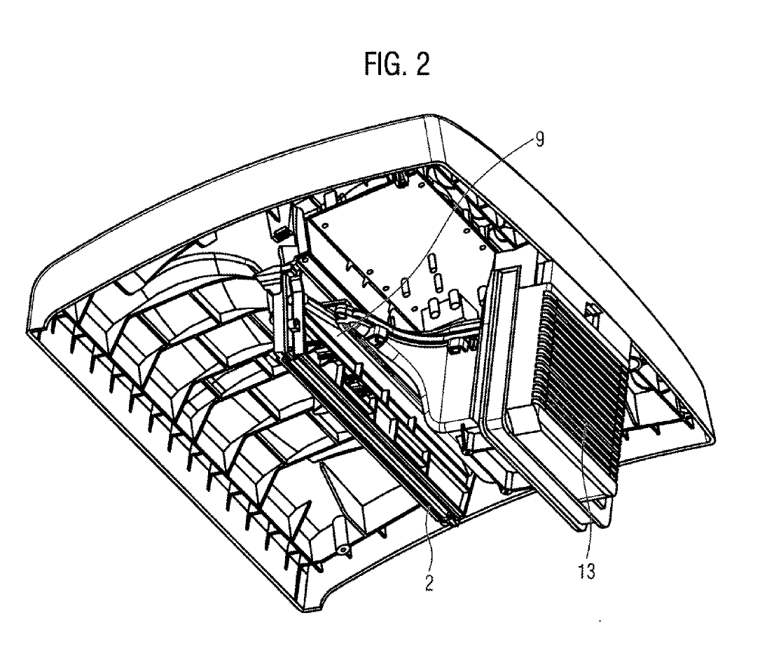

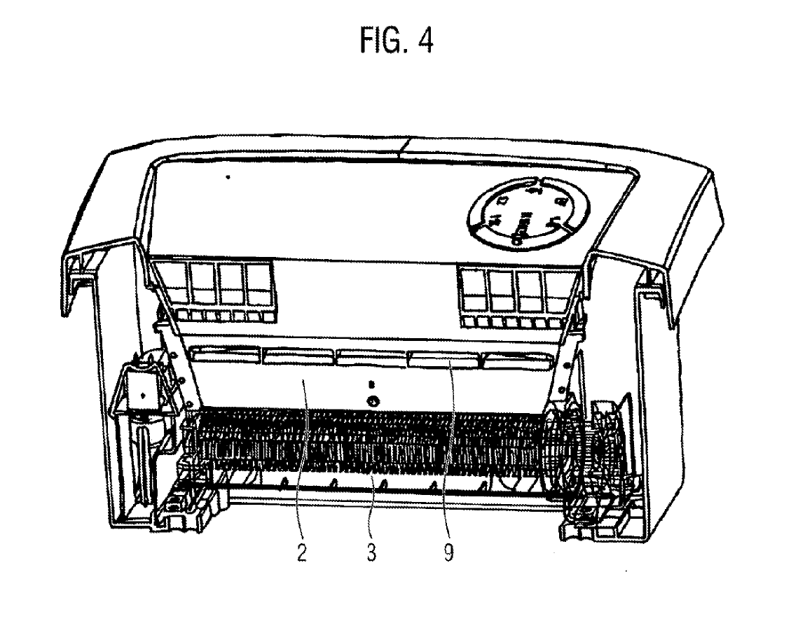

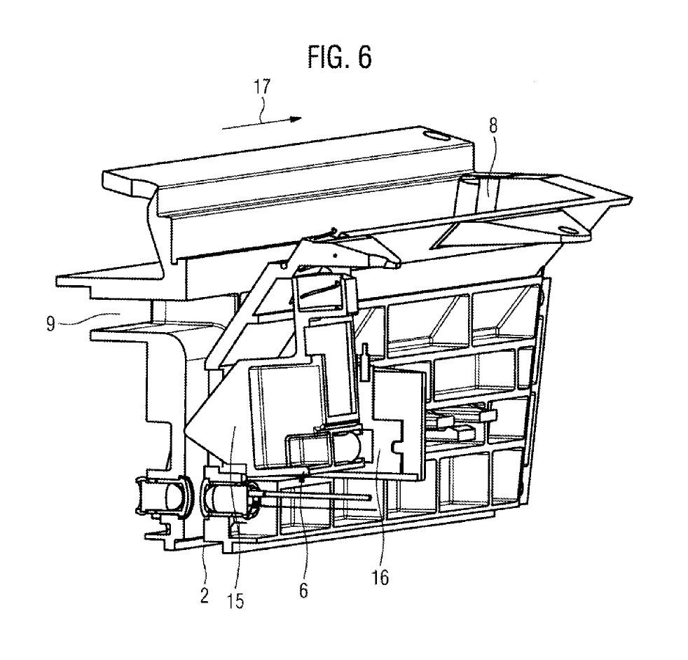

The feed channel 2 has a rectangular cross section, which is shown particularly well by the view of FIG. 2. Fitted to one long side of the feed channel 2 is the intake nozzle 9 of the suction extraction device 5, which FIG. 4 shows particularly well. Arranged opposite the intake nozzle 9, as shown by FIG. 6, is the detector 6 for measuring the thickness of the material to be comminuted. The detector 6 in this case comprises a mobile sensing finger 15 projecting into the feed channel 2 and the thin-film potentiometer 16 interacting with the sensing finger 15. If, for example, a stack of paper sheets is pushed into the infeed hopper 8, this stack passes through the feed channel 2 as far as the sensing finger 15. As soon as the stack of paper sheets in the feed channel 2 reaches the sensing finger 15, the stack of paper sheets moves the sensing finger 15 out in the outward movement direction 17. The outward movement of the sensing finger 1 in the outward movement direction 17 is measured by the thin-film potentiometer 16 and converted into an electric signal. If the thickness of the stack of paper sheets corresponds to the permissible dimension, the thin-film potentiometer gives the control system of the drive motor 4 the command to start up the cutting unit 3. On the other hand, if the stack of paper sheets is too thick, an appropriate visual or acoustic signal is given. The drive motor 4 switches off or runs backwards in order to stop the stack of paper sheets running further into the feed channel 2 and in particular into the cutting unit 3.

Arranged above the cutting unit 3 is the trough 18. The width of the trough 18 corresponds approximately to the width of a cutting roll in the cutting unit 3. The trough 18 is arranged above one cutting roll of the cutting unit 3. On the trough wall 19 which faces the second cutting roll of the cutting unit 3, the trough 18 has a multiplicity of apertures 20. Through the apertures 20, oil collected in the trough 18 can escape in the direction of the cutting unit 3. For the purpose of uniform distribution of the oil in the trough 18, webs 21 project from the base of the trough 18. The webs 21 are arranged offset from one another in order to form a labyrinth. The webs 21 effect static equal distribution of the quantity of oil located in the trough 18. The trough 18 is connected to the oil storage container 23 via the feed line 22. At predefined intervals, the feed line 22 introduces oil into the trough 18. This oil lubricates the cutting unit 3, reduces the inherent friction and thus effectively prevents the cutting unit 3 from being clogged with cutting material to be comminuted.

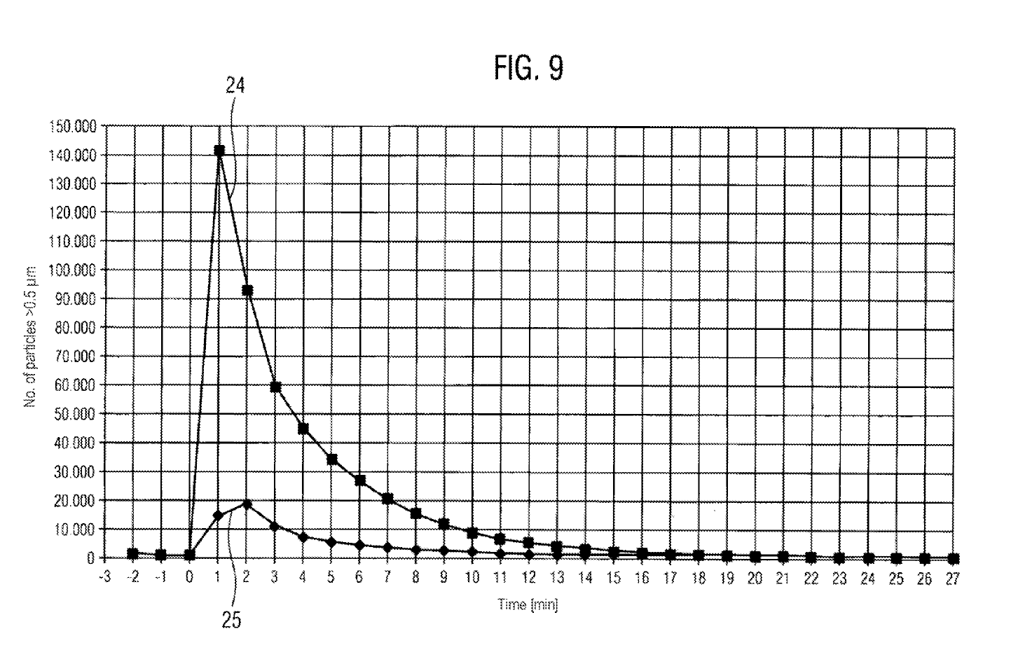

FIG. 9 finally shows a curve 24. The curve 24 indicates the number of particles greater than 0.5 μm which are produced during the conventional comminution operation with a document shredder according to the prior art. At the instant of a cut, 140,000 particles are emitted. After 2 min, this quantity falls to 90,000 particles, after 3 min to 60,000 particles. The further values can be gathered from the curve 24 in FIG. 9. After about 15 minutes, the emission of fine dust particles stops.

The second curve shown in FIG. 9, curve 25, shows the fine dust emission from a document shredder according to the invention having the suction extraction device 5. Here, after 2 min, a maximum of 20,000 particles are emitted. The remaining particles are filtered out by the filter element and thus do not emit into the surroundings at all. Furthermore, the maximum quantity of emitted particles is already halved again after a further minute and approaches the zero line again very much more quickly.

The functioning of the document shredder according to the invention is as follows: Through the infeed hopper 8, the material to be comminuted is fed into the document shredder in the infeed direction 26. Here, the material to be comminuted firstly passes the sensing finger 15 of the detector 6. If the detector 6 releases the material to be comminuted for comminution, the drive motor 4 and thus the cutting unit 3 start up and, at the same time, so does the suction fan 10 of the suction extraction device 5. The cutting unit 3 lubricated by the lubricating device 7 comminutes the material to be comminuted. Heat is produced in the cutting unit 3 here. The warm air rising from the cutting unit 3 in the feed channel 2 counter to the infeed direction 26 contains fine dust particles. These fine dust particles, together with the warm air and fine dust particles otherwise present, are sucked out of the feed channel 2 via the intake nozzle 9 of the suction extraction device 5 into the suction extraction device 5. The suction fan 10 sucks in the air stream with the fine dust particles and leads it away via the filter element 10 through the terminating grille 13 to the surroundings. Here, the fine dust particles are filtered out by the filter element 11, while the air substantially purified of the fine dust particles escapes into the surroundings via the terminating grille 13. The major part of the fine dust particles is thus removed from the air stream. In order to prevent the air stream from returning into the feed channel 2 and the emission of further fine dust particles, the suction fan 10 continues to run for a certain time after the drive motor 4 has been switched off.

The following is a list of reference numerals and the corresponding elements described in the above specification:
1 Housing cover
2 Feed channel
3 Cutting unit
4 Drive motor
5 Suction extraction device
6 Detector
7 Lubricating apparatus
8 Infeed hopper
9 Intake nozzle
10 Suction fan
11 Filter element
12 Blow-out end
13 Terminating grille
14 Suction direction
15 Sensing finger
16 Thin-film potentiometer
17 Outward movement direction
18 Trough
19 Trough wall
20 Aperture
21 Web
22 Feed line
23 Oil storage container
24 Curve—particle output from document shredder without suction extraction device
25 Curve—Document shredder with suction extraction device for fine dust particles
26 Infeed direction

1. A document shredder, comprising:
a housing wall formed with an infeed opening into a feed channel for material to be comminuted;
a cutting unit following the feed channel in an infeed direction of the material to be comminuted;
a suction extraction device having an intake end opening into said feed channel for extracting an air stream out of said feed channel, said suction extraction device having a filter element at a blow-out opening for filtering out fine dust particles before warm air extracted by said suction extraction device is blown out of the document shredder housing into the surroundings.

2. The document shredder according to claim 1, wherein said feed channel is widened at said infeed opening to form an infeed hopper, and said suction extraction device is formed with an intake opening into said infeed hopper.

3. The document shredder according to claim 2, wherein said infeed opening is widened in the form of an intake nozzle tapering in a direction of the feed channel,

4. The document shredder according to claim 1, which comprises a suction fan disposed upstream of said filter element in a suction direction, and wherein a cross section of said suction extraction device widens in a nozzle shape from an intake end in a direction toward said suction fan.

5. The document shredder according to claim 1, wherein said filter element comprises a multi-layer filter insert made of microfibers.

6. The document shredder according to claim 1, wherein said feed channel has a rectangular cross section with a long side, and said intake end of said suction extraction device opens into said long side.

7. The document shredder according to claim 1, which comprises a detector for measuring a thickness of the material to be comminuted on one long side of said feed channel, and the intake end of said suction extraction device is formed in an opposite long side of said feed channel.

8. A suction extraction device, comprising:
an integral component having an intake end formed as an intake nozzle, a suction fan a filter element communicating with said intake end, and a terminating grille mounted downstream of said filter element and forming a termination of a blow-out end;
said integral component being configured for installation in the document shredder according to claim 1.

9. A document shredder, comprising:
a housing wall formed with an infeed opening leading into a feed channel for material to be comminuted, said feed channel having a rectangular cross section;
a cutting unit following said feed channel in an infeed direction of the material to be comminuted;
a detector disposed on one long side of said feed channel for measuring a thickness of the material to be comminuted, said detector having a sensing finger projecting into said feed channel and being movably disposed in an outward movement direction transversely with respect to a infeed direction of the material to be comminuted, and a thin-film potentiometer controlled by the sensing finger.

10. The document shredder according to claim 9, which comprises a suction extraction device having an intake end opening into said feed channel for extracting an air stream out of said feed channel, said suction extraction device having a filter element at a blow-out opening for filtering out fine dust particles before warm air extracted by said suction extraction device is blown out of the document shredder housing into the surroundings.

11. The document shredder according to claim 9, wherein said detector is arranged on one long side of said feed channel, and the intake end of said suction extraction device is arranged on an opposite long side of said feed channel.

12. The document shredder according to claim 9, wherein said rectangular feed channel is assembled from two half shells of C-shaped cross section with the mouths of the respective C-shapes facing each other in such a way that one half shell forms a connecting part for said suction extraction device and that the other, opposite half shell forms a carrier part for said detector.

13. A document shredder, comprising:
a cutting unit having two cooperating cutting rolls for comminuting material to be comminuted therebetween;
a trough formed above a first of said cutting rolls, extending over a shaft width of said cutting roll and having a multiplicity of apertures in a trough wall facing a second of said cutting rolls, and having a labyrinth in a trough interior formed by a plurality of webs arranged offset from one another and standing up from a trough base; and
a charging device for filling said trough with lubricating oil at preset intervals for a regular lubrication of said cutting unit with lubricating oil.

14. The document shredder according to claim 1, wherein said cutting unit comprises two cooperating cutting rolls for comminuting material to be comminuted therebetween, a trough formed above a first of said cutting rolls, extending over a shaft width of said cutting roll and having a multiplicity of apertures in a trough wall facing a second of said cutting rolls, and having a labyrinth in a trough interior formed by a plurality of webs arranged offset from one another and standing up from a trough base, and a charging device for filling said trough with lubricating oil at preset intervals for a regular lubrication of said cutting unit with lubricating oil.

15. The document shredder according to claim 9, wherein said cutting unit comprises two cooperating cutting rolls for comminuting material to be comminuted therebetween, a trough formed above a first of said cutting rolls, extending over a shaft width of said cutting roll and having a multiplicity of apertures in a trough wall facing a second of said cutting rolls, and having a labyrinth in a trough interior formed by a plurality of webs arranged offset from one another and standing up from a trough base, and a charging device for filling said trough with lubricating oil at preset intervals for a regular lubrication of said cutting unit with lubricating oil.
